(19) United States
(12) Patent Application Publication
(10) Pub. No.: US 2026/0236657 A1
(43) Pub. Date: Aug. 13, 2026

(54) AUTOMATIC PARAMETER CONTROL FOR INTEGRATED CIRCUIT DESIGN FLOWS

(71) Applicant: INTERNATIONAL BUSINESS MACHINES CORPORATION, ARMONK, NY (US)

(72) Inventors: Gregor Boronowsky, Böblingen (DE); Silvia Melitta Mueller, St. Ingbert (DE); Michael Kazda, Poughkeepsie, NY (US)

(21) Appl. No.: 19/082,858

(22) Filed: Mar. 18, 2025

(30) Foreign Application Priority Data
Feb. 13, 2025 (GB) 2502114.8

(51) Int. Cl. G06F 30/337; G06N 3/092

(52) U.S. Cl. CPC G06F 30/337; G06N 3/092

(57) ABSTRACT

According to one embodiment, a method, computer system, and computer program product for automatic parameter control of integrated circuit design flows is provided. The present invention may include training a machine learning model through Reinforcement Learning using training data to generate a trained machine learning model, wherein the training data comprises previously executed design flow stages for different specific circuit designs, wherein the previously executed design flow stages comprise a sequence of flow stages, original input states, input parameters for each flow stage, and a quality of result (QoR) for an output state of a final flow stage within the sequence of flow stages; and processing unexecuted design flow stages for the different specific circuit designs through the trained machine learning model to generate an optimal set of input parameters for each flow stage in the unexecuted design flow stages for the different specific circuit designs.

### BACKGROUND

The present invention relates, generally, to the field of computing, and particularly, to automatic parameter control for integrated circuit design flows.

The design flow for integrated circuits comprises a sequence of different flow stages, such as floor planning, synthesis, placement, clock tree synthesis, and routing. The design flow is controlled by parameters which alter the output of each step. Ideally, the process to identify the parameters results in a placed and routed design that meets timing on given constraints with the least power.

### SUMMARY

Embodiments of a method, a computer system, and a computer program product for automatic parameter control for integrated circuit design flows comprising a sequence of different flow stages are described. According to one embodiment, a method, computer system, and computer program product for automatic parameter control for integrated circuit design flows comprising a sequence of different flow stages may include training a machine learning model through Reinforcement Learning using training data to generate a trained machine learning model, wherein the training data comprises previously executed design flow stages for a plurality of different specific circuit designs, wherein each of the previously executed design flow stages comprises a sequence of flow stages, a set of original input states, a set of input parameters for each flow stage within the sequence of flows stages, and a quality of result (QoR) score for an output state of a final flow stage within the sequence of flow stages based on the set of input parameters for each of the flow stages; and processing one or more unexecuted design flow stages for the plurality of different specific circuit designs through the trained machine learning model to generate an optimal set of input parameters for each flow stage within the sequence of flow stages in the one or more unexecuted design flow stages for the plurality of different specific circuit designs.

### BRIEF DESCRIPTION OF THE SEVERAL VIEWS OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts a flow of a computer implemented method for automatic parameter control for integrated circuit design flows according to an embodiment of the invention.

FIG. 2 depicts a flow of the method according to a further embodiment of the invention.

FIG. 3 depicts further details of the embodiment according to FIG. 2.

FIG. 4 depicts quality values obtained with the machine learning model.

FIG. 5 depicts quality values obtained with the machine learning model.

FIG. 6 depicts a schematic interpretation of the quality values according to FIG. 4 and FIG. 5.

FIG. 7 depicts a flow chart of the training of the machine learning model according to a further embodiment of the invention.

FIG. 8 depicts continuous token embeddings according to a further embodiment of the invention.

FIGS. 9A, 9B, and 9C depict design flow execution results in a previously existing dataset compared with two design flow executions per design where the machine learning model makes the decisions.

FIG. 10 depicts an example embodiment of a data processing system for executing a method according to the invention.

It will be appreciated that for simplicity and clarity of illustration, elements shown in the FIGS. have not necessarily been drawn to scale. For example, the dimensions of some of the elements may be exaggerated relative to other elements for clarity. Further, where considered appropriate, reference numbers may be repeated among the FIGS. to indicate corresponding or analogous features.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

As previously stated, the design flow for integrated circuits comprises a sequence of different flow stages, such as floor planning, synthesis, placement, clock tree synthesis and routing. The design flow is controlled by parameters which alter the output of each step. The process to identify the parameters which result in a placed and routed design that meets timing on given constraints with the least power is a non-trivial process. It would entail running the tool, making observations about the results, using intuition and knowledge about the design and tool to make changes in parameters to improve the observed results. These optimization problems can be complex and difficult to solve. The design process for each flow stage requires time, compute resources, engineering expertise and, even then, the end result may be far from optimal. Configuration parameters such as power consumption or wiring congestion of the integrated circuit may be optimized during the design process.

A computer implemented method for automatic parameter control for integrated circuit design flows is proposed, training a machine learning model through Reinforcement Learning using training data to generate a trained machine learning model, wherein the training data comprises previously executed design flow stages for a plurality of different specific circuit designs, wherein each of the previously executed design flow stages comprises a sequence of flow stages, a set of original input states, a set of input parameters for each flow stage within the sequence of flows stages, and a quality of result (QoR) score for an output state of a final flow stage within the sequence of flow stages based on the set of input parameters for each of the flow stages; and processing one or more unexecuted design flow stages for the plurality of different specific circuit designs through the trained machine learning model to generate an optimal set of input parameters for each flow stage within the sequence of flow stages in the one or more unexecuted design flow stages for the plurality of different specific circuit designs.

Advantageously, the invention allows for an optimization of a given circuit design, in particular concerning timing closure, power minimization, area minimization, clock frequency maximization, and routability. Thus, quality of result may be defined, e.g., for concerning timing closure, power minimization, area minimization, clock frequency maximization, and routability. An objective function to be optimized may be comprised of a weighted sum of targets.

A term “state” is used in Reinforcement Learning terminology and describes in this case the state of a design at a certain intermediate state during the design synthesis process. A state 0 would be an input design, e.g., a netlist. A state 1 would be the design after a first step of the design flow, e.g., a placement design. A state might additionally include other constants, variables or parameters of the design flow that are not directly generated or decided on by the machine learning model.

A flow stage is a single step of the design synthesis process, e.g., a placement process, a clock-tree process. A flow stage 0, e.g., the placement algorithm, transforms a state 0, e.g., the netlist, into a state 1, e.g., the placed design. The transformation of state 0 to state 1 is dependent on a set of parameters of the flow stage 0.

A so-called observation comprises a set of features, describing a specific state.

A so-called action comprises a complete or partial set of parameters for a specific flow stage, generated by the machine learning model.

The proposed method relies on features describing the design at various flow stages of the flow and adapts its recommendations based on these. In conjunction with training the machine learning model on a large set of designs, this allows the machine learning model to generalize to unseen designs or share knowledge between different designs. The described method can learn from commonalities and/or differences between different designs and gain an understanding of how a certain type of design reacts to a certain set of parameters. This makes it more data and compute efficient and enables recommending good parameters even for new designs, which consequently improves a turnaround time.

Considering the features describing a specific design at a given flow stage allows the proposed method to react to run-to-run variation caused by non-determinism of the flow stages. This may further improve the quality of results as well as reduce run-to-run variation of the quality of result.

Only part of previous observations and sets of parameters of previous flow stages may be used for creating a new set of parameters.

Using Reinforcement Learning (RL) allows to break down the parameter decision problem into a sequential decision problem, where the decision on parameters for a given stage are deferred until just before the stage is executed. This allows to maximize the information available at the time the decision is made. This is in contrast to black-box methods, which have to make and lock all parameter decisions in advance. Additional flexibility like this also allows the method to react to non-determinism in the involved stages.

Using RL allows to make all parameter decisions with respect to metrics measuring the quality of result (QoR) of the final stage of the flow without solely relying on possibly inaccurate or biased handcrafted intermediate metrics.

Using machine learning (ML) in general may reduce the overall effort (time, compute) spent to find optimal parameters while increasing the quality of the parameters by sharing general learned rules between multiple designs or iterations of the same design. While classical optimization methods have to start parameter optimization essentially from scratch, ML methods can leverage and apply what they learned on other designs.

RL also offers the advantage of being able to learn parameter decision policies that surpass those that were observed, which further amplifies time and resource savings.

In an embodiment, Monte-Carlo-based RL methods may be used to deal with non-determinism such as run-to-run variation.

In an additional or alternative embodiment of the invention, each flow stage may generate an output state from an input state given a set of parameters specific to the flow stage, each input state being either the output state of a previous flow stage or the input state to the entire design flow, having a dataset for at least one circuit design, comprising a set of states or observations describing the sequence of states produced by the sequence of flow stages by extracted features, the sets of parameters for each flow stage used to generate the states and a final quality of result of the last state of the sequence of states. Thus, run time for an optimization of design parameters during the design flow process may be saved.

In an additional or alternative embodiment of the invention, training of the machine learning model using Reinforcement Learning may be performed offline, wherein the result of the training is stored as a trained neural network. Favorably, the machine learning model may be trained for a given dataset before actually being used during the online design flow process.

The used offline or batch RL training methods may consider the uncertainty/risk of decisions. The risk here comes from the fact that there may only be limited evidence in the available data for the evaluation of a decision and the model's estimate of the quality value might be inaccurate. The used training methods may attempt to reduce the quality score associated with particular decisions to reflect that uncertainty or otherwise take the risk into account.

Favorably, the uncertainty or risk of decisions may be estimated using a secondary ML model. The estimate of uncertainty or risk may be used to reduce the estimate of the quality value of decisions or exclude decisions entirely.

In an additional or alternative embodiment of the invention, fine tuning of the machine learning model may be performed using Reinforcement Learning during the integrated circuit design flow. Fine tuning may be performed in direct interaction with the design synthesis process.

In an additional or alternative embodiment of the invention, the method may further comprise the machine learning model receiving previous states or observations describing states by extracted features of the states and/or previous sets of parameters of previous flow stages after having finished a specific flow stage, creating an actual set of parameters for the next flow stage. Thus, run time for an optimization of design parameters during the design flow process may be saved.

In an additional or alternative embodiment of the invention, the method may further comprise a set of at least two options for each parameter of the set of parameters for a specific stage. These options may comprise the complete set of options of a parameter, or a subset formulated based on expert knowledge of the parameter and the specific stage. Favorably, the subset is comprised of options that induce sufficiently different behavior of the specific stage.

In an additional or alternative embodiment of the invention, creating a set of parameters may comprise selecting parameters based on a quality value and/or probability for each possible parameter option as determined by the machine learning model depending on previous states and parameters of the respective flow stage. Favorably, an optimal result may be generated for a final quality of result.

Favorably, the possible flow stages of the circuit design flow may e.g., comprise one of a placement stage, a clock tree stage, or a signal routing stage. So, optimizing the design synthesis process may be performed sequentially for the different flow stages.

In an additional or alternative embodiment of the invention, features and parameters may be converted into a sequence of tokens, a token representing one or more of the features and/or the parameters, wherein the sequence of tokens is deployed to a sequence model as input creating quality values or probabilities for parameter options. Thus, a favorable sequence modelling approach may be applied to the design synthesis process.

In an additional or alternative embodiment of the invention, the parameters of the set of parameters of a stage of the design flow may be generated sequentially, wherein the previously selected parameter is converted into a token and appended to the sequence of tokens. This allows the model to consider interdependencies between parameter decisions.

In an additional or alternative embodiment of the invention, the quality value may reflect a predicted final quality of result (QoR) at the end of the design flow. An overall optimization may be achieved by such optimizing goals.

In an additional or alternative embodiment of the invention, the method may further comprise continuous embeddings of tokens by linear or non-linear transformation of low dimensional feature values into a vector space of higher dimensions. The parameters that govern this transformation may be learned alongside the other weights of the machine learning model. The transformations and the parameters governing the transformation may be specific to the feature and/or parameter that is being transformed. Thus, a loss of information by discretization of continuous feature values may be avoided.

In an additional or alternative embodiment of the invention, training the machine learning model may comprise accumulated data from previous circuit design flows from various sources, in particular, dedicated data gathering, designer-executed design flows and/or design flows executed by other parameter optimization methods. Favorably, the data comprises previous circuit design flows of many different designs and parameter options.

In an additional or alternative embodiment of the invention, the machine learning model at least may comprise auxiliary neural networks, in particular a graph neural network and/or a convolutional neural network. These auxiliary neural networks may be used to generate representations of the circuit design state's netlist, placement and/or routing if they are available in a state. Favorably, the auxiliary neural networks may be pre-trained, e.g., by applying self-supervised training methods. Additional optimization of the training process may be realized.

In an additional or alternative embodiment of the invention, rewards may be generated from accumulated data as input for the Reinforcement Learning training, such that higher rewards reflect a higher final quality of result (QoR). Further optimizing of the training process is possible. Rewards are optimizing criteria used in the machine learning model training.

In an additional or alternative embodiment of the invention, the final quality of result may be a composition, in particular a weighted sum, of one or more metrics of the final state of the circuit design. The metrics may be normalized or otherwise preprocessed with respect to all available data.

Favorably, features and parameters may be preprocessed before training the machine learning model. The same preprocessing may be applied before deploying features and parameters to the trained machine learning model as part of the parameter generation process.

Favorably, the training data may additionally comprise a set of calibration data. Calibration data may include circuit design flow executions of one or more circuit designs using a fixed set of parameters as input to each stage.

In an additional or alternative embodiment of the invention, calculating the quality of result may comprise normalizing metrics using a deviation of the values from a mean of a set of calibration data divided by the mean of the set of calibration data or by a standard deviation of the calibration data. An advantageous normalization of the resulting quality of result may be achieved.

In an additional or alternative embodiment of the invention, calculating the quality of result may comprise, if no calibration data are available, normalizing metrics using a deviation of the values from a mean of the values divided by the mean of the values. An advantageous normalization of the resulting quality of result may be achieved, too.

The final quality of result is essentially the underlying target to be optimized. This quality of result typically may be a composition, favorably a weighted sum, of several metrics.

For RL training, this final quality of result score is mapped to a reward. Higher quality of result values generally imply a higher reward, but this relation does not have to be linear.

The quality value of a parameter option is the score the model generates with which the decision is made. The quality value is highly related to the reward and quality of result, but might generally also depend on additional factors such as the risk.

Further, a computer system for automatic parameter control for integrated circuit design flows is proposed, comprising a computer processing unit storing computer executable instructions to perform the method, comprising training a machine learning model through Reinforcement Learning using training data to generate a trained machine learning model, wherein the training data comprises previously executed design flow stages for a plurality of different specific circuit designs, wherein each of the previously executed design flow stages comprises a sequence of flow stages, a set of original input states, a set of input parameters for each flow stage within the sequence of flows stages, and a quality of result (QoR) score for an output state of a final flow stage within the sequence of flow stages based on the set of input parameters for each of the flow stages; and processing one or more unexecuted design flow stages for the plurality of different specific circuit designs through the trained machine learning model to generate an optimal set of input parameters for each flow stage within the sequence of flow stages in the one or more unexecuted design flow stages for the plurality of different specific circuit designs.

The proposed computer system may advantageously be used for automatic parameter control for integrated circuit design flows.

Further, a computer program product for automatic parameter control for integrated circuit design flows is proposed, the computer program product comprising a computer readable storage medium having program instructions embodied therewith, the program instructions executable by the computer system to cause the computer system to perform the method, comprising: training a machine learning model through Reinforcement Learning using training data to generate a trained machine learning model, wherein the training data comprises previously executed design flow stages for a plurality of different specific circuit designs, wherein each of the previously executed design flow stages comprises a sequence of flow stages, a set of original input states, a set of input parameters for each flow stage within the sequence of flows stages, and a quality of result (QoR) score for an output state of a final flow stage within the sequence of flow stages based on the set of input parameters for each of the flow stages; and processing one or more unexecuted design flow stages for the plurality of different specific circuit designs through the trained machine learning model to generate an optimal set of input parameters for each flow stage within the sequence of flow stages in the one or more unexecuted design flow stages for the plurality of different specific circuit designs.

The proposed computer program product may advantageously be used for automatic parameter control for integrated circuit design flows.

Further, a data processing system for execution of a data processing program comprising computer readable program instructions for performing the method is proposed.

The proposed data processing system may advantageously be used for automatic parameter control for integrated circuit design flows.

The present invention together with the above-mentioned and other objects and advantages may best be understood from the following detailed description of the embodiments, but not restricted to the embodiments.

The illustrative embodiments described herein provide a computer implemented method for automatic parameter control for integrated circuit design flows comprising a sequence of different flow stages is proposed, each flow stage taking as input a state and a set of parameters for executing the flow stage and generating an output state, wherein the input state is the input state to the design flow or the output state of a previous stage, wherein the output state of the last flow stage of the sequence of flow stages is the output of the design flow for the specific circuit design, wherein a quality of the circuit design is determined by a final quality of result of the output state of the design flow. The method comprises training a machine learning model using Reinforcement Learning, using previous data of at least one design flow execution for at least one specific circuit design of a plurality of circuit designs, wherein the data comprises sets of states of the at least one design flow execution for the at least one specific circuit design and sets of parameters for each flow stage of the at least one design flow execution for the at least one specific circuit design and the corresponding quality of result for the at least one specific circuit design executed based on the set of parameters for each flow stage; creating the sets of parameters for the different flow stages using the machine learning model for at least one of the plurality of circuit designs to predict a set of parameters for at least one of the flow stages in the design flow, wherein the created set of parameters for the at least one of the flow stages in the design flow is decided to yield an improved quality of result for the output state of the final stage of the design flow for the at least one of the plurality of designs.

An agent receives features and metrics descriptive of all states, as well as all parameters of all previously executed non-final stages of the design flow. These features may comprise data in the form of vectors, graphs (for example to represent a netlist) or 2D/3D maps (for example to represent a routed or placed design).

The data is pre-processed. The agent generates an optimized parameter configuration for the next stage in the flow that is to be executed.

Deferring the generation of the optimal parameters for a given stage in the flow until immediately before that stage is executed allows the agent to consider the actual outcome of all previous stages. That is, it does not have to solely rely on a prediction of the outcome of previous stages made in advance. Doing so allows the agent to react to non-deterministic outcomes not otherwise known in advance.

The agent is comprised of one or multiple neural networks. These neural networks may comprise different types, including but not limited to convolutional neural networks, graph neural networks and transformer neural networks. Once trained, these neural network models embody the learned policy with which parameter decisions are made.

The agent is trained using methods from Reinforcement Learning. The training data may be comprised of data of previously executed iterations of the flow. The training data may comprise iterations of one or more different designs.

The training data comprises features and metrics descriptive of the design before and after every stage in the design flow. The training data also comprises all used parameters to all stages. These parameters may have been generated by a human, by the agent itself and/or by another automated method.

Generally, the training data is preprocessed. For the purpose of training, preprocessing may include generating quality of result (QoR) scores and rewards based on the QoR scores.

Generating QoR scores may include making the QoR scores of multiple different designs or different iterations of the design flow comparable.

Making QoR scores comparable may require a set of design flow iterations with a fixed set of parameters for all included designs. Making QoR scores comparable may then include normalization of all QoR scores with respect to the QoR scores of the design flow iterations with a fixed set of parameters.

Features descriptive of the design at various stages of the flow are also preprocessed. The nature of this preprocessing depends on the exact model and data being used. For example, in one embodiment of this method, features are turned into tokens.

Insufficient training data to achieve the desired results may be supplemented by executing additional iterations of the design flow. Hereby, previously trained agents can be used to generate parameters during these iterations. If done so, the agent can be improved by continuously updating it based on newly generated data (this is known as online learning).

The agent is trained to generate parameters, preferably optimal parameters, to a given stage in the flow. To do so, a value estimate or probability for every option for each of the parameters to the tool is generated. The value estimate or probability is generated by the agent given features and metrics descriptive of all or some of the previous states, as well as all or some of the parameters of all previously executed non-final stages of the design flow.

By means of the used training methods, the quality value or probability depends on an estimated quality of results of the design after the final stage of the design flow (final QoR). The quality value or probability may additionally depend on an explicit or implicit estimate of certainty, reflecting how risky a decision is with regards to the accuracy of the estimated quality value. For instance, a decision for which little evidence is available in the data may be considered risky, as the accuracy of the estimated quality of results as determined by the ML model may not be sufficient.

Typically, the parameter option with the highest estimated quality value is selected. If a stage has more than one parameter, the set of parameters may be generated in parallel or in sequence. If the parameters are generated in sequence, a previously generated parameter subsequently becomes part of the input of the model and is therefore taken into consideration by the model when deciding on further parameters (autoregressive). When using a sequence model, this may be achieved by converting the previously generated parameter into a token and appending it to the sequence of input tokens.

The quality values generated by the model may inform additional actions. In particular, if the quality values fall below a predefined threshold, such actions may include aborting the current iteration of the flow or rewinding to an earlier stage of the flow.

In the drawings, like elements are referred to with equal reference numerals. The drawings are merely schematic representations, not intended to portray specific parameters of the invention. Moreover, the drawings are intended to depict only typical embodiments of the invention and therefore should not be considered as limiting the scope of the invention.

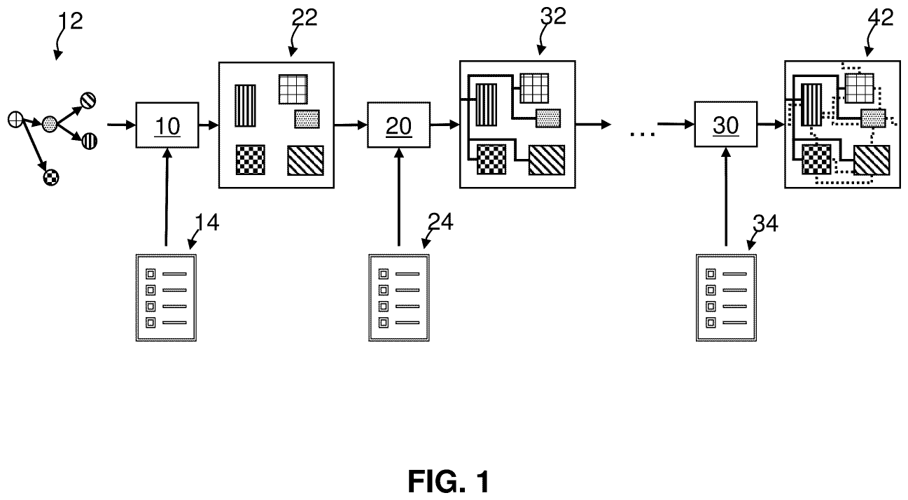

FIG. 1 depicts a flow of a computer implemented method for automatic parameter control for integrated circuit design flows according to an embodiment of the invention.

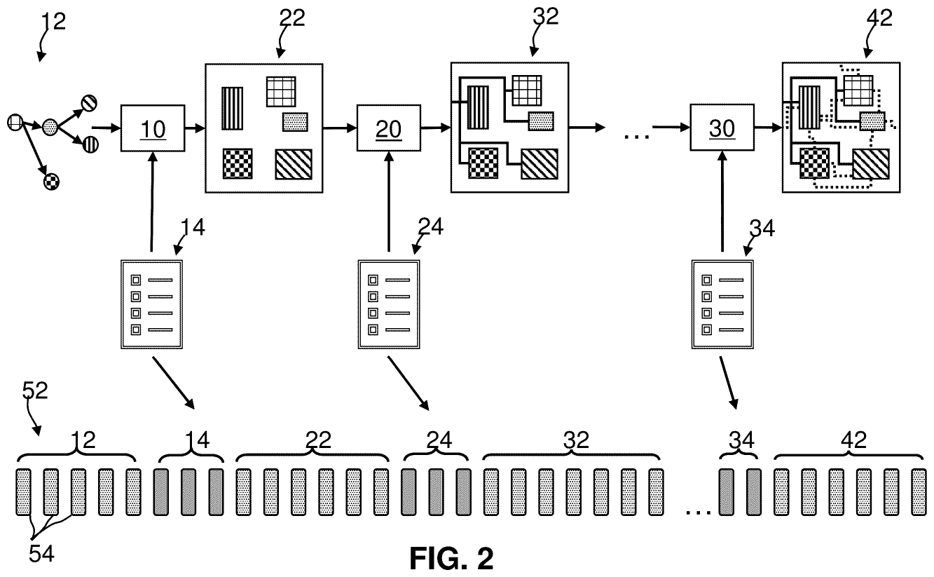

The integrated circuit design flows comprise a sequence of different flow stages 10, 20, 30. Possible flow stages 10, 20, 30 of the circuit design flow e.g., may comprise a placement stage 10, a clock tree stage 20, or a signal routing stage 30, as is depicted in FIG. 1. Input to the design flow may e.g., be a netlist 12 with specific different circuit components, depicted as circles symbolized with different patterns. The depicted flow stages 10, 20, 30 may only be an example of a design flow. In real world design flows a plurality of flow stages may be used for an integrated circuit design, as indicated in FIGS. 1 and 2 by a dotted line between state 32 and flow stage 30.

Each flow stage 10, 20, 30 has a set of parameters 14, 24, 34 for executing the flow stage 10, 20, 30 for a specific circuit design.

Each flow stage 10, 20, 30 generates an actual state 22, 32, 42 as an output from a previous state 12, 22, 32 with a previous set of parameters 14, 24, 34 as an input. For instance, flow stage 10 generates an actual state 22 as an output from previous state 12, flow stage 20 generates an actual state 32 as an output from previous state 22, and the last flow stage 30 generates an actual state 42 as an output from a previous state.

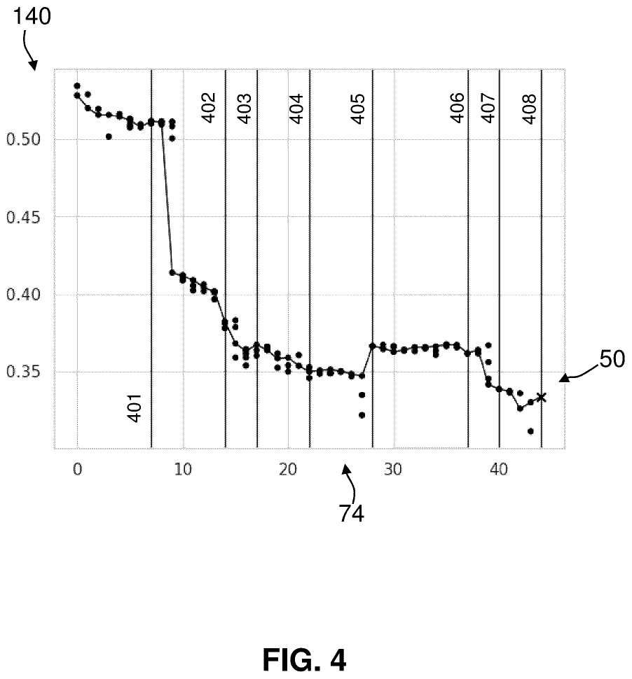

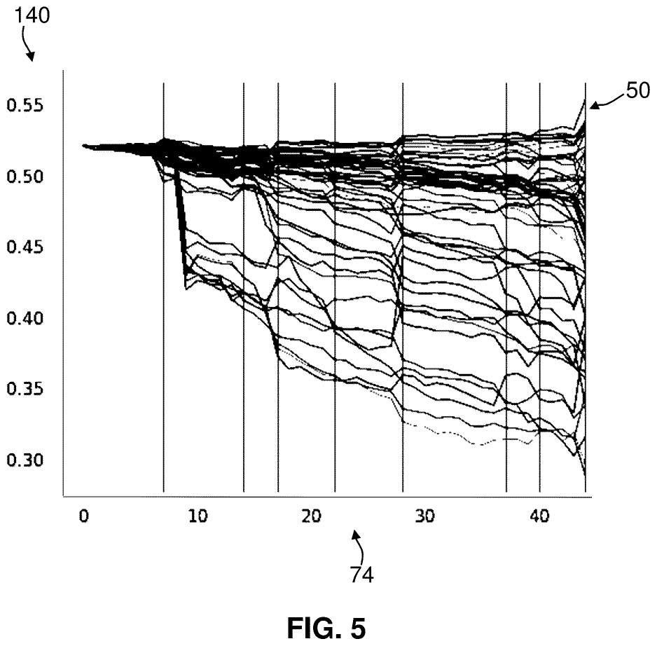

A quality of the circuit design is determined by a final quality of result 50 of the output state 42 of a last flow stage 30 of the sequence of flow stages 10, 20, 30. Achieved quality of result values 50 are depicted in FIGS. 4 and 5, respectively, as an example.

The method comprises training a machine learning model using Reinforcement Learning, using previous data of design flow stages 10, 20, 30 for at least one specific circuit design. The data comprises the sets of states 12, 22, 32, 42 of the circuit design and a set of parameters 14, 24, 34 for each flow stage 10, 20, 30 for the at least one specific circuit design as an input and the corresponding quality of result 50 for the at least one specific circuit design executed based on the set of parameters 14, 24, 34 for each flow stage 10, 20, 30.

Next sets of parameters 14, 24, 34 of the different flow stages 10, 20, 30 are created using the machine learning model to predict an optimal set of parameters 14, 24, 34 for each flow stage 10, 20, 30 in the design flow for the specific circuit design.

The created set of parameters 14, 24, 34 for a given flow stage 10, 20, 30 in the design flow is decided optimizing the expected resulting quality of result 50 for the final state 42 of the given flow stage 10, 20, 30.

Each flow stage 10, 20, 30 generates an actual state 12, 22, 32, 42 as an output from a previous state 12, 22, 32, 42 with a previous set of parameters 14, 24, 34 as an input, having a dataset for at least one circuit design, comprising a set of observations 52 (see FIG. 2) describing states 12, 22, 32, 42 by extracted features of the flow stage 10, 20, 30, a number of sets of parameters 14, 24, 34 and a final quality of result 50 of a last state 12, 22, 32, 42 from a number of states 12, 22, 32, 42 of a specific flow stage 10, 20, 30.

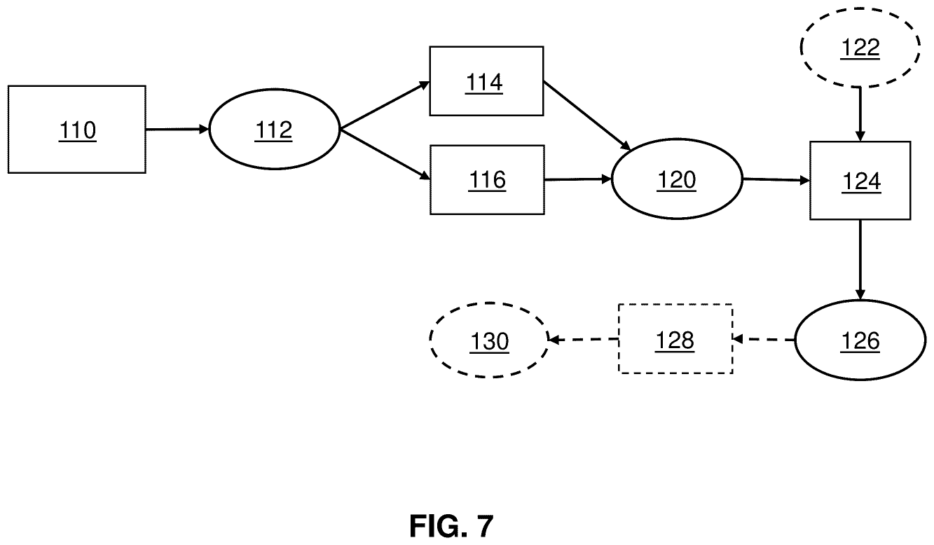

Rewards (see FIG. 7) are used by the Reinforcement Learning method as optimizing criteria leading to final quality of results 50 for the different states 12, 22, 32, 42.

Training of the machine learning model using Reinforcement Learning may favorably be performed offline, wherein the result of the training is stored as a trained neural network 126 (FIG. 7).

Fine tuning of the machine learning model may be performed using Reinforcement Learning during the integrated circuit design flow.

The machine learning model receives previous states 12, 22, 32, 42 and/or previous sets of parameters 14, 24, 34 of previous flow stages 10, 20, 30 after having finished a specific flow stage 10, 20, 30. Based on that, an actual set of parameters 14, 24, 34 for the next flow stage 10, 20, 30 is then created.

Creating a set of parameters 14, 24, 34 is based on an evaluation of each possible parameter option, wherein the evaluation is determined by the machine learning model.

FIG. 2 depicts a flow of the method according to a further embodiment of the invention.

In this embodiment features and parameters of a flow stage 10, 20, 30 are converted into a sequence of tokens 54, the tokens 54 each representing one or more of the features and/or the parameters 14, 24, 34, thus contributing to uniformity.

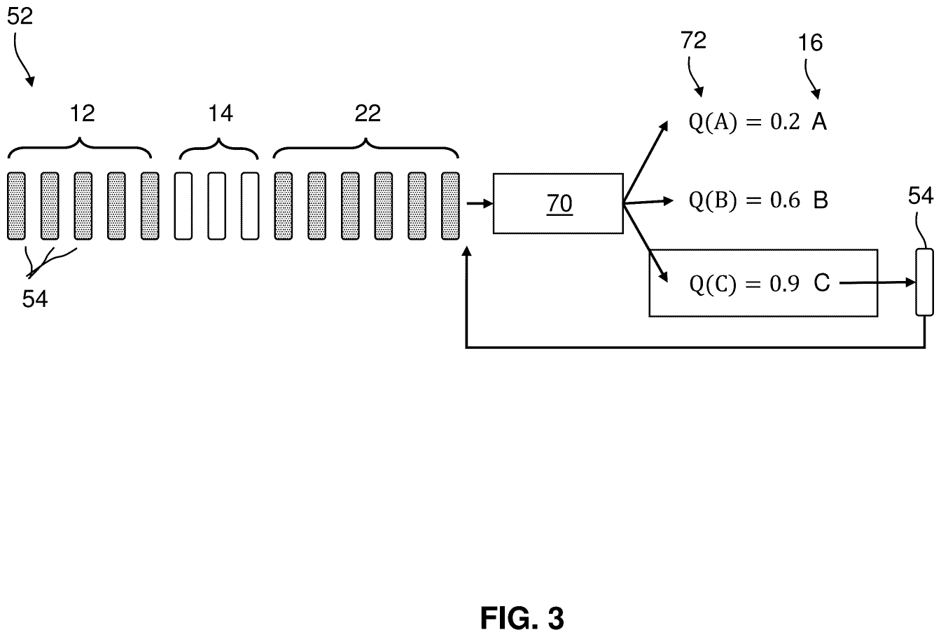

As is depicted in FIG. 3, the sequence of tokens 54 of FIG. 2 is deployed to a sequence model 70 as input creating quality values 72 for the possible parameter options 16, A, B, C with which parameters are selected. In the example shown, the parameter option 16, C, is selected as it is connected to the highest quality value 72 of 0.9.

The token 54 represents the parameter choice C as an example. The parameter choice C is fed back by appending the token 54 to the sequence. Then the next parameter choice is made, taking the previous choice into account because it is now part of the sequence that is deployed to the model.

In one embodiment, the process of token embedding might involve discretization of the feature values.

In another embodiment, the process of token embedding might involve a linear or non-linear transformation of low dimensional feature values into a vector space of higher dimension. The parameters governing this transformation may be learned alongside the other weights of the machine learning model. The transformations and the parameters governing the transformation may be specific to the feature and/or parameter that is being transformed.

The iterations may be incomplete, meaning that only a subset of stages 10, 20, 30 have been executed.

FIG. 4 depicts expected final reward values 140 given by the model to test data withheld from the training process where parameters decisions were made randomly by an external method.

The final reward values 140 are plotted depending on decisions 74 taken during the different steps 401 to 408 of different flow stages 10, 20, 30 of a circuit design flow process.

The final reward value 140 reflects the final quality of result 50.

FIG. 5 depicts expected final reward values 140 given by the model to test data withheld from the training process where parameters decisions were made randomly by an external method. Better results of the design flow exhibit higher final reward values 140 with an approximately constant behavior with increasing number of decisions.

FIG. 4, as well as FIG. 5, only show the model “judging” parameter decisions made on previously unseen executions of the design flow. Those decisions were not influenced by this method. But those diagrams show the quality values that the model generates and that they are quite accurate even for unseen executions of the design flow with unseen sets of parameters.

The expected final reward values 140 are plotted depending on decisions 74 taken at random during the different steps 401 to 408 of different flow stages 10, 20, 30.

The final reward value 140 delivers the final quality of result 50.

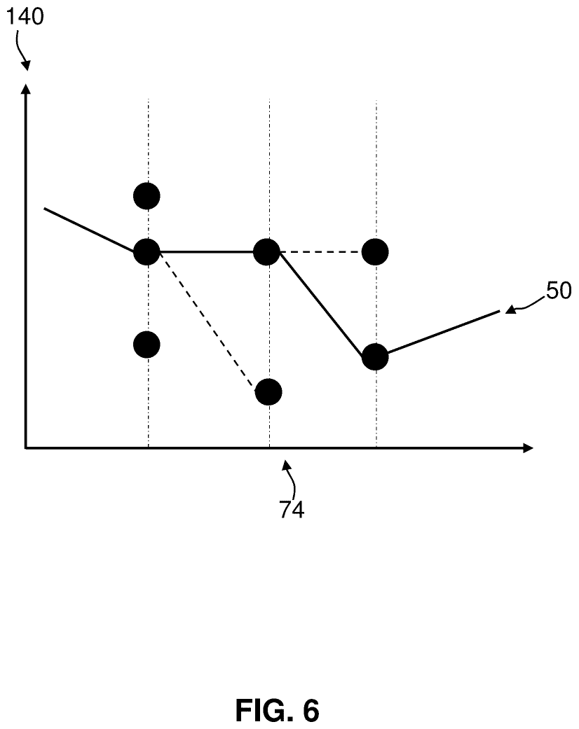

In FIG. 5, a number of different lines show possible developments of final reward values 140 if different decisions are made for the selection of parameters. The best decisions are represented by approximately horizontal lines, as explained during discussion of FIG. 6.

FIG. 6 depicts a schematic interpretation of the final reward values 140 according to FIG. 5.

It shows proposed final reward values 140 for different values of each parameter. Each parameter is shown on the vertical line and different y-axis values of the final reward value 140.

Here proposed final reward values 140 for three different decisions, symbolized by vertical lines, are plotted. The points representing the final reward values 140 are connected by solid lines, leading to the final quality of result 50, according to the decisions taken. Approximately, horizontal lines represent optimal decisions, descending lines represent suboptimal decisions, but approximation errors and non-deterministic behavior of the stages may lead to deviations from this expected behavior.

As may be seen from FIG. 6, if only optimal decisions were taken, a higher quality of result 50 might be achieved, contrarily to the actual quality of result 50.

FIG. 7 depicts a flow chart of the training of the machine learning model according to a further embodiment of the invention. Elliptic symbols represent products, rectangular symbols represent processes, dashed symbols represent optional products or processes.

Training of the machine learning model comprises accumulated data 112 are gathered from previous circuit design flows from various sources, in particular dedicated data gathering and/or designer-executed design flows 110.

Final reward values 140 are generated in step 114 from the accumulated data 112 as input for the Reinforcement Learning training 124.

In parallel the accumulated data 112 may be pre-processed in step 116 delivering pre-processed data as a Reinforcement learning dataset 120.

This dataset 120 may be fed to the offline or batch Reinforcement Learning training 124 delivering the trained neural network 126.

Optionally training the machine learning model may comprise a pre-trained graph neural network and/or a convolutional network model 122 as input for the Reinforcement Learning training 124.

Also, in a further optional step 128, online Reinforcement Learning fine tuning may be performed resulting in a fine-tuned model 130.

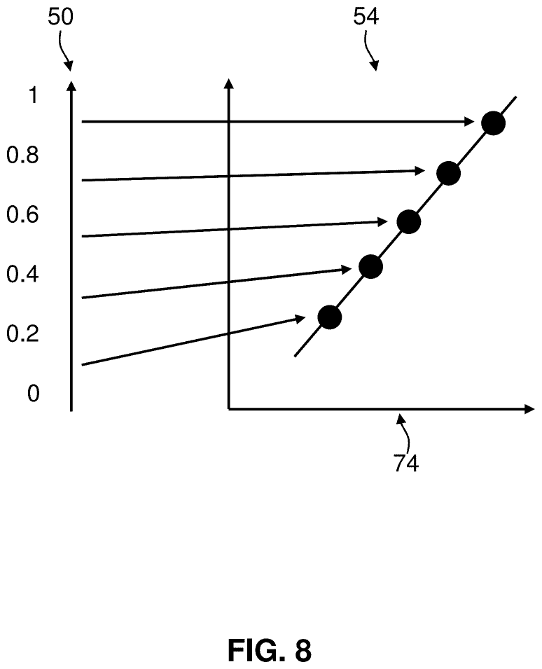

FIG. 8 depicts continuous token embeddings according to a further embodiment of the invention.

By this way low dimensional feature values 50 are mapped to a vector space of higher dimension 54 by linear or non-linear transformation. The parameters that govern this transformation may be learned alongside the other weights of the machine learning model. Advantageously, there is no loss of information through discretization, ordinality is preserved, as well as relative distances between the different feature values 50 are preserved. A linear transformation of a feature value, x, to a higher dimensional vector, y, through learned parameter matrix, A, and parameter vector, b, can be represented by the following equation:

$$y = A x + b$$

According to a further, not depicted, embodiment, values, x, for a metric may be normalized using a deviation of the values, x, from a mean of a set of calibration data, mean_{cal}(x), divided by the mean of the set of calibration data, mean_{cal}(x), as represented by the following equation:

$$\frac{x - {mean}_{cal} ( x )}{{mean}_{cal} ( x )}$$

Thus, only few calibration samples are required. This is a favorable interpretation of values as relative improvement.

According to a further, not depicted, embodiment, values, x, for a metric may be normalized using a deviation of the values, x, from a mean of a set of calibration data, mean_{cal}(x), divided by a standard deviation of the calibration data, std_{cal}(x)+∈, as represented by the following equation:

$$\frac{x - {mean}_{c a l} ( x )}{{std}_{c a l} ( x ) + ϵ}$$

A small value can be represented by ∈.

Thus not-parameter-induced variance may be reduced. It is probably best, if sufficient calibration data to estimate standard deviation are available.

If no calibration data is available, values, x, for a metric are normalized using a deviation of the values from a mean of the values, x−mean(x), divided by the mean of the values, mean(x), as represented by the following equation:

$$\frac{x - mean ( x )}{mean ( x )}$$

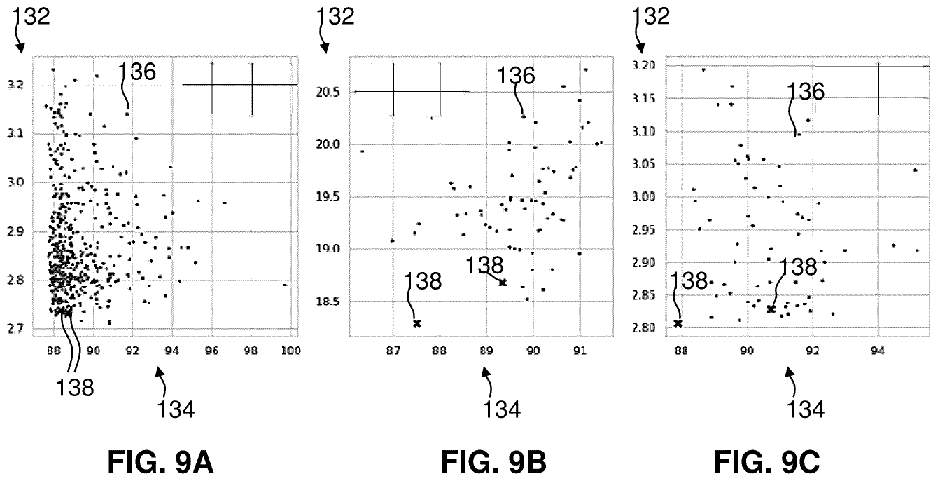

FIGS. 9A, 9B, and 9C depict design flow execution results 136 of a previously existing dataset (marked as round points) together with two design flow executions (marked as x) 138 where the machine learning model makes the decisions on three different designs, one per FIGS. 9A, 9B, and 9C.

In FIGS. 9A, 9B, and 9C results 136 for a design flow execution with previously existing datasets and results 138 where the machine learning model makes the decisions are shown according to a congestion metric 134 and a power metric 132. For both metrics, 132 and 134, a lower result is considered better.

The results 138 depicted in FIGS. 9A, 9B, and 9C demonstrate that the machine learning model can attain lower power metrics 132 and congestion metrics 134 by choosing parameters well and therefore perform as well as or better than the best design flow executions results 136 in the previously existing dataset.

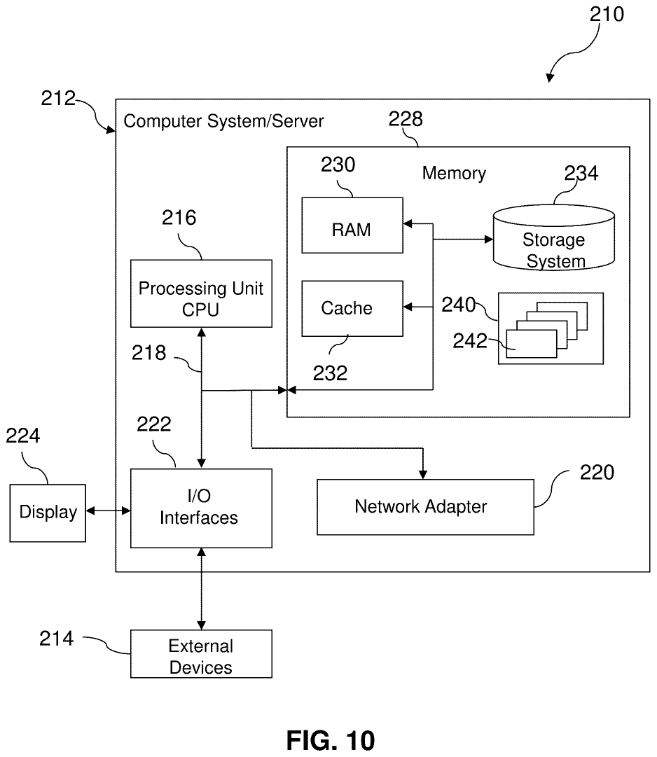

Referring now to FIG. 10, a schematic of an example of a data processing system 210 is shown. Data processing system 210 is only one example of a suitable data processing system and is not intended to suggest any limitation as to the scope of use or functionality of embodiments of the invention described herein. Regardless, data processing system 210 is capable of being implemented and/or performing any of the functionality set forth herein above.

In data processing system 210 there is a computer system/server 212, which is operational with numerous other general-purpose or special-purpose computing system environments or configurations. Examples of well-known computing systems, environments, and/or configurations that may be suitable for use with computer system/server 212 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 212 may be described in the general context of computer system executable instructions, such as program modules, being executed by a computer system. Generally, program modules may include routines, programs, objects, components, logic, data structures, and so on that perform particular tasks or implement particular abstract data types. Computer system/server 212 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 10, computer system/server 212 in data processing system 210 is shown in the form of a general-purpose computing device. The components of computer system/server 212 may include, but are not limited to, one or more processors or processing units 216, a system memory 228, and a bus 218 that couples various system components including system memory 228 to processor 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 212 typically includes a variety of computer system readable media. Such media may be any available media that is accessible by computer system/server 212, and it includes both volatile and non-volatile media, removable and non-removable media.

System memory 228 can include computer system readable media in the form of volatile memory, such as random access memory (RAM) 230 and/or cache memory 232. Computer system/server 212 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of the invention.

Program/utility 240, having a set (at least one) of program modules 242, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 242 generally carry out the functions and/or methodologies of embodiments of the invention as described herein.

Computer system/server 212 may also communicate with one or more external devices 214 such as a keyboard, a pointing device, a display 224, etc.; one or more devices that enable a user to interact with computer system/server 212; and/or any devices (e.g., network card, modem, etc.) that enable computer system/server 212 to communicate with one or more other computing devices. Such communication can occur via Input/Output (I/O) interfaces 222. Still yet, computer system/server 212 can communicate with one or more networks such as a local area network (LAN), a general wide area network (WAN), and/or a public network (e.g., the Internet) via network adapter 220. As depicted, network adapter 220 communicates with the other components of computer system/server 212 via bus 218. It should be understood that, although not shown, other hardware and/or software components could be used in conjunction with computer system/server 212. Examples, include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the FIGS. illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the FIGS. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special-purpose hardware-based systems that perform the specified functions or acts or carry out combinations of special-purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method for automatic parameter control of integrated circuit design flows, the method comprising:
training a machine learning model through Reinforcement Learning using training data to generate a trained machine learning model, wherein the training data comprises previously executed design flow stages for a plurality of different specific circuit designs, wherein each of the previously executed design flow stages comprises a sequence of flow stages, a set of original input states, a set of input parameters for each flow stage within the sequence of flows stages, and a quality of result (QoR) score for an output state of a final flow stage within the sequence of flow stages based on the set of input parameters for each of the flow stages; and
processing one or more unexecuted design flow stages for the plurality of different specific circuit designs through the trained machine learning model to generate an optimal set of input parameters for each flow stage within the sequence of flow stages in the one or more unexecuted design flow stages for the plurality of different specific circuit designs.

2. The method of claim 1, wherein each flow stage in the sequence of flow stages generates an output state from an input state given its corresponding set of input parameters specific to its respective flow stage, wherein the input state is either an output state of a previous flow stage in the sequence of flow stages or an input state of a first flow stage in the sequence of flow stages, wherein the set of input parameters specific to a respective flow stage comprises a dataset for at least one specific circuit design, wherein the dataset comprises a set of observations describing a sequence of states using extracted features from the sequence of flow stages, and wherein the set of input parameters specific for each of the flow stages are used to generate a final QoR score for a last state within the sequence of states.

3. The method of claim 1, wherein each of the flow stages in the plurality of different specific circuit designs comprises its corresponding set of input parameters for executing its respective flow stage to generate the output state.

4. The method of claim 1, wherein the generated optimal set of input parameters for each flow stage within the sequence of flow stages are determined based on achieving an improved QoR score for the output state of a final stage within the sequence of flow stages in at least one unseen execution of the design flow, and wherein the generated optimal set of input parameters for a given flow stage in a design flow are generated before the given flow stage is executed, based on extracted features describing an input state of the design flow and input parameters of each previous flow stage within the sequence of flow stages in the design flow for its respective specific circuit design.

5. The method of claim 1, the method further comprising:
the machine learning model receiving previous states or observations describing states by extracted features of the states and/or previous sets of parameters of previous flow stages after having finished a specific flow stage; and
creating an actual set of parameters for a next flow stage.

6. The method of claim 1, wherein creating a set of optimal parameters comprises selecting parameters based on a quality value and/or probability for each parameter option as determined by the machine learning model depending on previous states and previous parameters of the respective flow stage.

7. The method of claim 1, wherein one or more features of each flow stage and a corresponding set of input parameters for each flow stage, within the sequence of flow stages, are converted into a sequence of tokens, wherein a token represents one of the one or more features and/or one of the set of input parameters, and wherein the sequence of tokens is deployed to a sequence model as input to create quality values or probabilities for each possible parameter option.

8. The method of claim 7, wherein a quality value reflects a predicted final QoR score of the output state of the final flow stage within the sequence of flow stages for a respective specific design flow.

9. The method of claim 8, further comprising:
converting continuous embeddings of the sequence of tokens by linear or non-linear transformation of low dimensional feature values into a vector space of higher dimension, wherein the transformations and parameters governing the transformations are specific to one of the one or more features that are being transformed.

10. The method of claim 9, wherein training the machine learning model further comprises learning the parameters that govern the transformations, fine tuning the machine learning model, and performing batch reinforcement learning.

11. The method of claim 1, wherein training the machine learning model further comprises using accumulated data sourced from dedicated data gathering, designer-executed design flow stages, and/or design flow stages executed by other parameter optimization methods.

12. The method of claim 1, wherein the trained machine learning model is a trained neural network comprising one or more auxiliary neural networks.

13. The method of claim 12, wherein the one or more auxiliary neural networks can be a pre-trained graph neural network and/or a pre-trained convolutional neural network model.

14. The method of claim 11, wherein one or more rewards are generated using the accumulated data during training of the machine learning model through the Reinforcement Learning, wherein higher rewards in the one or more rewards correspond to higher final QoR scores.

15. The method of claim 1, wherein the final QoR score is a composition of one or more metrics of the final state of the circuit design.

16. The method of claim 1, wherein a QoR score is calculated with normalizing metrics using a deviation of values from a mean of a set of calibration data divided by either the mean of the set of calibration data or a standard deviation of the calibration data.

17. The method of claim 16, wherein calculating the QoR score comprises, if no calibration data is available, normalizing metrics using the deviation of the values from the mean of the values divided by the mean of the values.

18. A computer system for automatic parameter control for integrated circuit design flows, the computer system comprising:
one or more computer processing units, one or more computer readable mediums, one or more computer readable storage mediums, and program instructions stored on at least one of the storage mediums for execution by at least one of the one or more computer processing units via at least one of the one or more mediums, wherein the computer system is capable of performing a method comprising:
training a machine learning model through Reinforcement Learning using training data to generate a trained machine learning model, wherein the training data comprises previously executed design flow stages for a plurality of different specific circuit designs, wherein each of the previously executed design flow stages comprises a sequence of flow stages, a set of original input states, a set of input parameters for each flow stage within the sequence of flows stages, and a quality of result (QoR) score for an output state of a final flow stage within the sequence of flow stages based on the set of input parameters for each of the flow stages; and
processing one or more unexecuted design flow stages for the plurality of different specific circuit designs through the trained machine learning model to generate an optimal set of input parameters for each flow stage within the sequence of flow stages in the one or more unexecuted design flow stages for the plurality of different specific circuit designs.

19. The computer system of claim 18, wherein the computer system is part of a data processing system.

20. A computer program product for automatic parameter control for integrated circuit design flows, the computer program product comprising:
one or more computer readable storage mediums and program instructions stored on at least one of the one or more storage mediums, the program instructions executable by a processor to cause the processor to perform a method comprising:
training a machine learning model through Reinforcement Learning using training data to generate a trained machine learning model, wherein the training data comprises previously executed design flow stages for a plurality of different specific circuit designs, wherein each of the previously executed design flow stages comprises a sequence of flow stages, a set of original input states, a set of input parameters for each flow stage within the sequence of flows stages, and a quality of result (QoR) score for an output state of a final flow stage within the sequence of flow stages based on the set of input parameters for each of the flow stages; and
processing one or more unexecuted design flow stages for the plurality of different specific circuit designs through the trained machine learning model to generate an optimal set of input parameters for each flow stage within the sequence of flow stages in the one or more unexecuted design flow stages for the plurality of different specific circuit designs.
